(19) United States
(12) Patent Application Publication
(10) Pub. No.: US 2014/0272815 A1
(43) Pub. Date: Sep. 18, 2014

(54) APPARATUS AND METHOD FOR PERFORMING ACTIONS BASED ON CAPTURED IMAGE DATA

(71) Applicants: Yonatan Wexler, Jerusalem (IL); Amnon Shashua, Mevaseret Zion (IL)

(72) Inventors: Yonatan Wexler, Jerusalem (IL); Amnon Shashua, Mevaseret Zion (IL)

(73) Assignee: OrCam Technologies Ltd., Jerusalem (IL)

(21) Appl. No.: 14/137,328

(22) Filed: Dec. 20, 2013

Related U.S. Application Data
(60) Provisional application No. 61/799,549, filed on Mar. 15, 2013.
(60) Provisional application No. 61/830,122, filed on Jun. 2, 2013.

(51) Int. Cl. G09B 21/00

(52) U.S. Cl. CPC G09B 21/006
USPC 434/116

(57) ABSTRACT

An apparatus and method are provided for performing one or more actions based on triggers detecting within captured image data. In one implementation, a method is provided for audibly reading text retrieved from a captured image. According to the method, real-time image data is captured from an environment of a user, and an existence of a trigger is determined within the captured image data. In one aspect, the trigger may be associated with a desire of the user to hear text read aloud, and the trigger identifies an intermediate portion of the text a distance from a level break in the text. The method includes performing a layout analysis on the text to identify the level break associated with the trigger, and reading aloud text beginning from the level break associated with the trigger.

### CROSS REFERENCE TO RELATED APPLICATIONS

This application claims the benefit of priority of U.S. Provisional Patent Application No. 61/799,649, filed on Mar. 15, 2013, and U.S. Provisional Patent Application No. 61/830,122, filed on Jun. 2, 2013, both of which are incorporated herein by reference in their entirety.

### BACKGROUND

I. Technical Field

This disclosure generally relates to devices and methods for providing information to a user. More particularly, this disclosure relates to devices and methods for providing information to a user by processing images captured from the environment of the user.

II. Background Information

Visual acuity is an indication of the clarity or clearness of a person's vision that is commonly measured twenty feet from an object. When measuring visual acuity, the ability of a person to identify black symbols on a white background at twenty feet is compared to the ability of a person with normal eyesight. This comparison can be symbolized by a ratio. For example, a ratio of 20/70 vision means a person located at a distance of twenty feet can see what a person with normal vision can see at seventy feet. A person has low vision if he or she has a visual acuity between 20/70 and 20/200 in the better-seeing eye that cannot be corrected or improved with regular eyeglasses. The prevalence of low vision is about one in a hundred for people in their sixties and rapidly increases to one in five for people in their nineties. Low vision may also depend on the environment. For example, some individuals may be able to see only when there is ample light.

A person may have low vision (also known as visual impairment) for several reasons. Other than eye damage and failure of the brain to receive visual cues sent by the eyes, different medical conditions may cause visual impairment. Medical conditions that may cause visual impairment include Age-related Macular Degeneration (AMD), retinitis pigmentosa, cataract, and diabetic retinopathy.

AMD, which usually affects adults, is caused by damage to the retina that diminishes vision in the center of a person's visual field. The lifetime risk for developing AMD is strongly associated with certain genes. For example, the lifetime risk of developing AMD is 50% for people that have a relative with AMD, versus 12% for people that do not have relatives with AMD.

Retinitis pigmentosa is an inherited, degenerative eye disease that causes severe vision impairment and often blindness. The disease process begins with changes in pigment and damage to the small arteries and blood vessels that supply blood to the retina. There is no cure for retinitis pigmentosa and no known treatment can stop the progressive vision loss caused by the disease.

A cataract is a clouding of the lens inside the eye which leads to a decrease in vision. Over time, a yellow-brown pigment is deposited within the lens and obstructs light from passing and being focused onto the retina at the back of the eye. Biological aging is the most common cause of a cataract, but a wide variety of other risk factors (e.g., excessive tanning, diabetes, prolonged steroid use) can cause a cataract.

Diabetic retinopathy is a systemic disease that affects up to 80% of all patients who have had diabetes for ten years or more. Diabetic retinopathy causes microvascular damage to a blood-retinal barrier in the eye and makes the retinal blood vessels more permeable to fluids.

People with low vision experience difficulties due to lack of visual acuity, field-of-view, color perception, and other visual impairments. These difficulties affect many aspects of everyday life. Persons with low vision may use magnifying glasses to compensate for some aspects of low vision. For example, if the smallest letter a person with 20/100 vision can read is five times larger than the smallest letter that a person with 20/20 vision can read, then 5× magnification should make everything that is resolvable to the person with 20/20 vision resolvable to the person with low vision. However, magnifying glasses are expensive and cannot remedy all aspects of low vision. For example, a person with low vision who wears magnifying glasses may still have a difficult time recognizing details from a distance (e.g., people, signboards, traffic lights, etc.). Accordingly, there is a need for other technologies that can assist people who have low vision accomplish everyday activities.

### SUMMARY

Embodiments consistent with the present disclosure provide devices and methods for providing information to a user by processing images captured from the environment of the user. The disclosed embodiments may assist persons who have low vision.

Consistent with disclosed embodiments, an apparatus audibly reads text retrieved from a captured image. In one aspect, the apparatus includes an image sensor configured to capture image data from an environment of a user, and at least one processor device configured to determine an existence of a trigger in the image data. The trigger may be associated with a desire of the user to hear text read aloud, and the trigger may identifies an intermediate portion of the text a distance from a level break in the text. The at least one processing device may be further configured to perform a layout analysis on the text to identify the level break associated with the trigger, and cause the text to be read aloud from the level break associated with the trigger.

Consistent with additional disclosed embodiments, an apparatus performs at least one action on text retrieved from a captured image. In one aspect, the apparatus includes an image sensor configured to be worn by a user and to capture image data from an environment of the user, and at least one processor device configured to determine an existence of a pointing trigger in the image data. The pointing trigger may identify an intermediate portion of the text proximate to a level break in the text. The at least one processor device may be further configured to perform a layout analysis on the text to identify a level break associated with the pointing trigger, and perform the at least one action on a portion of the text associated with the identified level break.

Consistent with further disclosed embodiments, a method for audibly reading text retrieved from a captured image includes capturing real time image data from an environment of a user, and determining an existence of a trigger in the image data. The trigger may be associated with a desire of the user to hear text read aloud, and the trigger may identify an intermediate portion of the text a distance from a level break in the text. The method may include performing a layout analysis on the text to identify the level break associated with the trigger, and reading aloud text beginning from the level break associated with the trigger.

Consistent with other disclosed embodiments, non-transitory computer-readable storage media may store program instructions, which are executed by at least one processor device and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 is a schematic illustration of a user wearing an apparatus for aiding persons who have low vision;

FIG. 2A is a schematic illustration of an example of a support from a first viewpoint;

FIG. 2B is a schematic illustration of the support shown in FIG. 2A from a second viewpoint;

FIG. 2C is a schematic illustration of the support shown in FIG. 2A mounted on a pair of glasses;

FIG. 2D is a schematic illustration of a sensory unit attached to the support that is mounted on the pair of glasses shown in FIG. 2C;

FIG. 2E is an exploded view of FIG. 2D;

FIG. 3A is a schematic illustration of an example of a sensory unit from a first viewpoint;

FIG. 3B is a schematic illustration of the sensory unit shown in FIG. 3A from a second viewpoint;

FIG. 3C is a schematic illustration of the sensory unit shown in FIG. 3A from a third viewpoint;

FIG. 3D is a schematic illustration of the sensory unit shown in FIG. 3A from a fourth viewpoint;

FIG. 3E is a schematic illustration of the sensory unit shown in FIG. 3A in an extended position;

FIG. 4A is a schematic illustration of an example of a processing unit from a first viewpoint;

FIG. 4B is a schematic illustration of the processing unit shown in FIG. 4A from a second viewpoint;

FIG. 5A is a block diagram illustrating an example of the components of an apparatus for aiding persons who have low vision according to a first embodiment;

FIG. 5B is a block diagram illustrating an example of the components of an apparatus for aiding persons who have low vision according to a second embodiment;

FIG. 5C is a block diagram illustrating an example of the components of an apparatus for aiding persons who have low vision according to a third embodiment;

FIG. 5D is a block diagram illustrating an example of the components of an apparatus for aiding persons who have low vision according to a fourth embodiment;

FIG. 6 illustrates an exemplary set of application modules and databases, according to disclosed embodiments;

FIGS. 7A-7F illustrate exemplary level breaks within captured image data, according to disclosed embodiments;

FIG. 8 is a flow diagram of an exemplary process for identifying and performing actions based on captured image data, according to disclosed embodiments;

FIG. 9 is a flow diagram of an exemplary process for performing multiple actions based on captured image data, according to disclosed embodiments;

FIG. 10 is a flow diagram of an exemplary process for adaptively performing actions based on captured image data, according to disclosed embodiments; and

FIG. 11 is a flow diagram of an exemplary process for suspending a performance of actions based on detected user behavior, according to disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Disclosed embodiments provide devices and methods for assisting people who have low vision. One example of the disclosed embodiments is a device that includes a camera configured to capture real-time image data from the environment of the user. The device also includes a processing unit configured to process the real-time image data and provide real-time feedback to the user. The real-time feedback may include, for example, an output that audibly identifies individuals from a distance, reads signboards, and/or identifies the state of a traffic light.

FIG. 1 illustrates a user 100 wearing an apparatus 110 connected to glasses 105, consistent with a disclosed embodiment. Apparatus 110 may provide functionality for aiding user 100 with various daily activities that are otherwise difficult for user 100 to accomplish due to low vision. Glasses 105 may be prescription glasses, magnifying glasses, non-prescription glasses, safety glasses, sunglasses, etc.

As shown in FIG. 1, apparatus 110 includes a sensory unit 120 and a processing unit 140. Sensory unit 120 may be connected to a support (not shown in FIG. 1) that is mounted on glasses 105. In addition, sensory unit 120 may include an image sensor (not shown in FIG. 1) for capturing real-time image data of the field-of-view of user 100. The term “image data” includes any form of data retrieved from optical signals in the near-infrared, infrared, visible, and ultraviolet spectrums. The image data may be used to form video clips and/or photographs.

Processing unit 140 may communicate wirelessly or via a wire 130 connected to sensory unit 120. In some embodiments, processing unit 140 may produce an output of audible feedback to user 100 (e.g., using a speaker or a bone conduction headphone).

Apparatus 110 is one example of a device capable of implementing the functionality of the disclosed embodiments. Other devices capable of implementing the disclosed embodiments include, for example, a mobile computer with a camera (e.g., a smartphone, a smartwatch, a tablet, etc.) or a clip-on-camera configured to communicate with a processing unit (e.g., a smartphone or a dedicated processing unit, which can be carried in a pocket). A person skilled in the art will appreciate that different types of devices and arrangements of devices may implement the functionality of the disclosed embodiments.

FIG. 2A is a schematic illustration of an example of a support 210. As discussed in connection with FIG. 1, support 210 may be mounted on glasses 105 and connect to sensory unit 120. The term “support” includes any device or structure that enables detaching and reattaching of a device including a camera to a pair of glasses or to another object (e.g., a helmet). Support 210 may be made from plastic (e.g., polycarbonate), metal (e.g., aluminum), or a combination of plastic and metal (e.g., carbon fiber graphite). Support 210 may be mounted on glasses 105 using screws, bolts, snaps, or any fastening means used in the art.

As shown in FIG. 2A, support 210 includes a base 230 connected to a clamp 240. A bridge 220 connects base 230 with clamp 240. Base 230 and clamp 240 enable sensory unit 120 to easily attach to and detach from support 210. In one embodiment, base 230 may include an internally threaded member 250 for cooperating with a screw (not shown in FIG. 2A) to mount support 210 on glasses 105.

FIG. 2B illustrates support 210 from a second viewpoint. The viewpoint shown in FIG. 2B is from a side orientation of support 210.

FIG. 2C illustrates support 210 mounted on glasses 105. Support 210 may be configured for mounting on any kind of glasses (e.g., eyeglasses, sunglasses, 3D glasses, safety glasses, etc.). As shown in FIG. 2C, sensory unit 120 is not attached to support 210 and, accordingly, support 210 may be sold separately from apparatus 110. This arrangement makes apparatus 110 compatible with a variety of glasses. For example, some users may have several pairs of glasses and may wish to mount a support on each pair of glasses.

In other embodiments, support 210 may be an integral part of a pair of glasses, or sold and installed by an optometrist. For example, support 210 may be configured for mounting on the arms of glasses 105 near the frame front, but before the hinge. Alternatively, support 210 may be configured for mounting on the bridge of glasses 105.

FIG. 2D illustrates sensory unit 120 attached to support 210 (not visible in FIG. 2D), and support 210 mounted on glasses 105. In some embodiments, support 210 may include a quick release mechanism for disengaging and reengaging sensory unit 120. For example, support 210 and sensory unit 120 may include magnetic elements. As an alternative example, support 210 may include a male latch member and sensory unit 120 may include a female receptacle.

When sensory unit 120 is attached (or reattached) to support 210, the field-of-view of a camera associated with sensory unit 120 may be substantially identical to the field-of-view of user 100. Accordingly, in some embodiments, after support 210 is attached to sensory unit 120, directional calibration of sensory unit 120 may not be required because sensory unit 120 aligns with the field-of-view of user 100.

In other embodiments, support 210 may include an adjustment component (not shown in FIG. 2D) to enable calibration of the aiming direction of sensory unit 120 in a substantially set position that is customized to user 100 wearing glasses 105. For example, the adjustment component may include an adjustable hinge to enable vertical and horizontal alignment of the aiming direction of sensory unit 120. Adjusting the alignment of sensory unit 120 may assist users who have a unique and individual visual impairment. The adjustment may be internal or external to sensory unit 120.

FIG. 2E is an exploded view of the components shown in FIG. 2D. Sensory unit 120 may be attached to glasses 105 in the following way. Initially, support 210 may be mounted on glasses 105 using screw 260. Next, screw 260 may be inserted into internally threaded member 250 (not shown in FIG. 2E) in the side of support 210. Sensory unit 120 may then be clipped on support 210 such that it is aligned with the field-of-view of user 100.

FIG. 3A is a schematic illustration of sensory unit 120 from a first viewpoint. As shown in FIG. 3A, sensory unit 120 includes a feedback-outputting unit 340 and an image sensor 350.

Sensory unit 120 is configured to cooperate with support 210 using clip 330 and groove 320, which fits the dimensions of support 210. The term “sensory unit” refers to any electronic device configured to capture real-time images and provide a non-visual output. Furthermore, as discussed above, sensory unit 120 includes feedback-outputting unit 340. The term “feedback-outputting unit” includes any device configured to provide information to a user.

In some embodiments, feedback-outputting unit 340 may be configured to be used by blind persons and persons with low vision. Accordingly, feedback-outputting unit 340 may be configured to output nonvisual feedback. The term “feedback” refers to any output or information provided in response to processing at least one image in an environment. For example, feedback may include a descriptor of a branded product, an audible tone, a tactile response, and/or information previously recorded by user 100. Furthermore, feedback-outputting unit 340 may comprise appropriate components for outputting acoustical and tactile feedback that people with low vision can interpret. For example, feedback-outputting unit 340 may comprise audio headphones, a speaker, a bone conduction headphone, interfaces that provide tactile cues, vibrotactile stimulators, etc.

As discussed above, sensory unit 120 includes image sensor 350. The term “image sensor” refers to a device capable of detecting and converting optical signals in the near-infrared, infrared, visible, and ultraviolet spectrums into electrical signals. The electric signals may be used to form an image based on the detected signal. For example, image sensor 350 may be part of a camera. In some embodiments, when sensory unit 120 is attached to support 210, image sensor 350 may acquire a set aiming direction without the need for directional calibration. The set aiming direction of image sensor 350 may substantially coincide with the field-of-view of user 100 wearing glasses 105. For example, a camera associated with image sensor 350 may be installed within sensory unit 120 in a predetermined angle in a position facing slightly downwards (e.g., 5-15 degrees from the horizon). Accordingly, the set aiming direction of image sensor 350 may match the field-of-view of user 100.

As shown in FIG. 3A, feedback-outputting unit 340 and image sensor 350 are included in a housing 310. The term “housing” refers to any structure that at least partially covers, protects, or encloses a sensory unit. The housing may be made from one or more different materials (e.g., plastic or aluminum). In one embodiment, housing 310 may be designed to engage with a specific pair of glasses having a specific support (e.g., support 210). In an alternative embodiment, housing 310 may be designed to engage more than one pair of glasses, each having a support (e.g., support 210) mounted thereon. Housing 310 may include a connector for receiving power from an external mobile-power-source or an internal mobile-power-source, and for providing an electrical connection to image sensor 350.

FIG. 3B is a schematic illustration of sensory unit 120 from a second viewpoint. As shown in FIG. 3B, housing 310 includes a U-shaped element. An inner distance “d” between each side of the U-shaped element is larger than the width of the arm of glasses 105. Additionally, the inner distance “d” between each side of the U-shaped element is substantially equal to a width of support 210. The inner distance “d” between each side of the U-shaped element may allow user 100 to easily attach housing 310 to support 210, which may be mounted on glasses 105. As illustrated in FIG. 3B, image sensor 350 is located on one side of the U-shaped element and feedback-outputting unit 340 is located on another side of the U-shaped element.

FIG. 3C is a schematic illustration of sensory unit 120 from a third viewpoint. The viewpoint shown in FIG. 3C is from a side orientation of sensory unit 120 and shows the side of the U-shaped element that includes image sensor 350.

FIG. 3D is a schematic illustration of sensory unit 120 from a fourth viewpoint. The viewpoint shown in FIG. 3D is from an opposite side of the orientation shown in FIG. 3C. FIG. 3D shows the side of the U-shaped element that includes feedback-outputting unit 340.

FIG. 3E is a schematic illustration of the sensory unit shown in FIG. 3A in an extended position. As shown in FIG. 3E, a portion of sensory unit 120 is extendable and wire 130 may pass through a channel of sensory unit 120. This arrangement may allow a user to adjust the length and the angle of sensory unit 120 without interfering with the operation of apparatus 110.

User 100 may adjust the U-shaped element of sensory unit 120 so that feedback-outputting unit 340 is positioned adjacent to the user's ear or the user's temple. Accordingly, sensory unit 120 may be adjusted for use with different users who may have different head sizes. Alternatively, a portion of sensory unit 120 may be flexible such that the angle of feedback-outputting unit 340 is relative to the user's ear or the user's temple.

FIG. 4A is a schematic illustration of processing unit 140. As shown in FIG. 4A, processing unit 140 has a rectangular shape, which easily fits in a pocket of user 100. Processing unit 140 includes a connector 400 for connecting wire 130 to processing unit 140. Wire 130 may be used to transmit power from processing unit 140 to sensory unit 120, and data to and from processing unit 140 to sensory unit 120. Alternatively, wire 130 may comprise multiple wires (e.g., a wire dedicated to power transmission and a wire dedicated to data transmission).

Processing unit 140 includes a function button 410 for enabling user 100 to provide input to apparatus 110. Function button 410 may accept different types of tactile input (e.g., a tap, a click, a double-click, a long press, a right-to-left slide, a left-to-right slide). In some embodiments, each type of input may be associated with a different action. For example, a tap may be associated with the function of confirming an action, while a right-to-left slide may be associated with the function of repeating the last output.

FIG. 4B is a schematic illustration of processing unit 140 from a second viewpoint. As shown in FIG. 4B, processing unit 140 includes a volume switch 420, a battery pack compartment 430, and a power port 440. In one embodiment, user 100 may charge apparatus 110 using a charger connectable to power port 440. Alternatively, user 100 may replace a battery pack (not shown) stored in battery pack compartment 430.

FIG. 5A is a block diagram illustrating the components of apparatus 110 according to a first embodiment. Specifically, FIG. 5A depicts an embodiment in which apparatus 110 comprises sensory unit 120 and processing unit 140, as discussed in connection with, for example, FIG. 1. Furthermore, sensory unit 120 may be physically coupled to support 210.

As shown in FIG. 5A, sensory unit 120 includes feedback-outputting unit 340 and image sensor 350. Although one image sensor is depicted in FIG. 5A, sensory unit 120 may include a plurality of image sensors (e.g., two image sensors). For example, in an arrangement with more than one image sensor, each of the image sensors may be face a different direction or be associated with a different camera (e.g., a wide angle camera, a narrow angle camera, an IR camera, etc.). In other embodiments (not shown in the figure) sensory unit 120 may also include buttons and other sensors such as a microphone and inertial measurements devices.

As further shown in FIG. 5A, sensory unit 120 is connected to processing unit 140 via wire 130. Processing unit 140 includes a mobile power source 510, a memory 520, a wireless transceiver 530, and a processor 540.

Processor 540 may constitute any physical device having an electric circuit that performs a logic operation on input or inputs. For example, processor 540 may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by processor 540 may, for example, be pre-loaded into a memory integrated with or embedded into processor 540 or may be stored in a separate memory (e.g., memory 520). Memory 520 may comprise a Random Access Memory (RAM), a Read-Only Memory (ROM), a hard disk, an optical disk, a magnetic medium, a flash memory, other permanent, fixed, or volatile memory, or any other mechanism capable of storing instructions.

Although one processor is shown in FIG. 5A, processing unit 140 may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically or by other means that permit them to interact.

In some embodiments, processor 540 may change the aiming direction of image sensor 350 using image data provided from image sensor 350. For example, processor 540 may recognize that a user is reading a book and determine that the aiming direction of image sensor 350 is offset from the text. That is, because the words in the beginning of each line of text are not fully in view, processor 540 may determine that image sensor 350 is tilted down and to the right. Responsive thereto, processor 540 may adjust the aiming direction of image sensor 350.

Processor 540 may access memory 520. Memory 520 may be configured to store information specific to user 100. For example, data for image representations of known individuals, favorite products, personal items, etc., may be stored in memory 520. In one embodiment, user 100 may have more than one pair of glasses, with each pair of glasses having support 210 mounted thereon. Accordingly, memory 520 may store information (e.g., personal settings) associated with each pair of glasses. For example, when a user wears his sunglasses may have different preferences than when the user wears reading glasses.

As shown in FIG. 5A, processing unit 140 includes mobile power source 510. Mobile power source 510 may be configured to power processing unit 140 and/or sensory unit 120. The term “mobile power source” includes any device capable of providing electrical power, which can be easily carried by a hand (e.g., the total weight of mobile power source 510 may be less than a pound). Thus, the mobility of the power source enables user 100 to use apparatus 110 in a variety of situations. For example, mobile power source 510 may include one or more batteries (e.g., nickel-cadmium batteries, nickel-metal hydride batteries, and lithium-ion batteries) or any other type of electrical power supply. In some embodiments, mobile power source 510 may be rechargeable and contained within a casing that holds processing unit 140. In other embodiments, mobile power source 510 may include one or more energy harvesting devices for converting ambient energy into electrical energy (e.g., portable solar power units, human vibration units, etc.).

Apparatus 110 may operate in a low-power-consumption mode and in a processing-power-consumption mode. For example, mobile power source 510 can produce five hours of processing-power-consumption mode and fifteen hours of low-power-consumption mode. Accordingly, different power consumption modes may allow mobile power source 510 to produce sufficient power for powering processing unit 140 for various time periods (e.g., more than two hours, more than four hours, more than ten hours, etc.).

Mobile power source 510 may power one or more wireless transceivers (e.g., wireless transceiver 530 in FIG. 5A). The term “wireless transceiver” refers to any device configured to exchange transmissions over an air interface by use of radio frequency, infrared frequency, magnetic field, or electric field. Wireless transceiver 530 may use any known standard to transmit and/or receive data (e.g., Wi-Fi, Bluetooth®, Bluetooth Smart, 802.15.4, or ZigBee). In some embodiments, wireless transceiver 530 may transmit data (e.g., raw image data or audio data) from image sensor 350 to processing unit 140, or wireless transceiver 530 may transmit data from processing unit 140 to feedback-outputting unit 340.

In another embodiment, wireless transceiver 530 may communicate with a different device (e.g., a hearing aid, the user's smartphone, or any wirelessly controlled device) in the environment of user 100. For example, wireless transceiver 530 may communicate with an elevator using a Bluetooth® controller. In such an arrangement, apparatus 110 may recognize that user 100 is approaching an elevator and call the elevator, thereby minimizing wait time. In another example, wireless transceiver 530 may communicate with a smart TV. In such an arrangement, apparatus 110 may recognize that user 100 is watching television and identify specific hand movements as commands for the smart TV (e.g., switching channels). In yet another example, wireless transceiver 530 may communicate with a virtual cane. A virtual cane is any device that uses a laser beam or ultrasound waves to determine the distance from user 100 to an object.

FIG. 5B is a block diagram illustrating the components of apparatus 110 according to a second embodiment. In FIG. 5B, similar to the arrangement shown in FIG. 5A, support 210 is used to couple sensory unit 120 to a pair of glasses. However, in the embodiment shown in FIG. 5B, sensory unit 120 and processing unit 140 communicate wirelessly. For example, wireless transceiver 530A can transmit image data to processing unit 140 and receive information to be outputted via feedback-outputting unit 340.

In this embodiment, sensory unit 120 includes feedback-outputting unit 340, mobile power source 510A, wireless transceiver 530A, and image sensor 350. Mobile power source 510A is contained within sensory unit 120. As further shown in FIG. 5B, processing unit 140 includes wireless transceiver 530B, processor 540, mobile power source 510B, and memory 520.

FIG. 5C is a block diagram illustrating the components of apparatus 110 according to a third embodiment. In particular, FIG. 5C depicts an embodiment in which support 210 includes image sensor 350 and connector 550B. In this embodiment, sensory unit 120 provides functionality for processing data and, therefore, a separate processing unit is not needed in such a configuration.

As shown in FIG. 5C, sensory unit 120 includes processor 540, connector 550A, mobile power source 510, memory 520, and wireless transceiver 530. In this embodiment, apparatus 110 does not include a feedback-outputting unit. Accordingly, wireless transceiver 530 may communicate directly with a hearing aid (e.g., a Bluetooth® hearing aid). In addition, in this embodiment, image sensor 350 is included in support 210. Accordingly, when support 210 is initially mounted on glasses 105, image sensor 350 may acquire a set aiming direction. For example, a camera associated with image sensor 350 may be installed within support 210 in a predetermined angle in a position facing slightly downwards (e.g., 7-12 degrees from the horizon). Furthermore, connector 550A and connector 550B may allow data and power to be transmitted between support 210 and sensory unit 120.

FIG. 5D is a block diagram illustrating the components of apparatus 110 according to a fourth embodiment. In FIG. 5D, sensory unit 120 couples directly to a pair of glasses without the need of a support. In this embodiment, sensory unit 120 includes image sensor 350, feedback-outputting unit 340, processor 540, and memory 520. As shown in FIG. 5D, sensory unit 120 is connected via a wire 130 to processing unit 140. Additionally, in this embodiment, processing unit 140 includes mobile power source 510 and wireless transceiver 530.

As will be appreciated by a person skilled in the art having the benefit of this disclosure, numerous variations and/or modifications may be made to the disclosed embodiments. Not all components are essential for the operation of apparatus 110. Any component may be located in any appropriate part of apparatus 110 and the components may be rearranged into a variety of configurations while providing the functionality of the disclosed embodiments. Therefore, the foregoing configurations are examples and, regardless of the configurations discussed above, apparatus 110 can assist persons who have low vision with their everyday activities in numerous ways.

One way apparatus 110 can assist persons who have low vision is by identifying relevant objects in an environment. For example, in some embodiments, processor 540 may execute one or more computer algorithms and/or signal-processing techniques to find objects relevant to user 100 in image data captured by sensory unit 120. The term “object” refers to any physical object, person, text, or surroundings in an environment.

In one embodiment, apparatus 110 can perform a hierarchical object identification process. In a hierarchical object identification process, apparatus 110 can identify objects from different categories (e.g., spatial guidance, warning of risks, objects to be identified, text to be read, scene identification, and text in the wild) of image data. For example, apparatus 110 can perform a first search in the image data to identify objects from a first category, and after initiating the first search, execute a second search in the image data to identify objects from a second category.

In another embodiment, apparatus 110 can provide information associated with one or more of the objects identified in image data. For example, apparatus 110 can provide information such as the name of an individual standing in front of user 100. The information may be retrieved from a dynamic database stored in memory 520. If the database does not contain specific information associated with the object, apparatus 110 may provide user 100 with nonvisual feedback indicating that a search was made, but the requested information was not found in the database. Alternatively, apparatus 110 may use wireless transceiver 530 to search for and retrieve information associated with the object from a remote database (e.g., over a cellular network or Wi-Fi connection to the Internet).

Another way apparatus 110 can assist persons who have low vision is by performing a continuous action that relates to an object in an environment. A continuous action may involve providing continuous feedback regarding the object. For example, apparatus 110 can provide continuous feedback associated with an object identified within a field-of-view of image sensor 350, and suspend the continuous feedback when the object moves outside the field-of-view of image sensor 350. Examples of continuous feedback may include audibly reading text, playing a media file, etc. In addition, in some embodiments, apparatus 110 may provide continuous feedback to user 100 based on information derived from a discrete image or based on information derived from one or more images captured by sensory unit 120 from the environment of user 100.

Another type of continuous action includes monitoring the state of an object in an environment. For example, in one embodiment, apparatus 110 can track an object as long as the object remains substantially within the field-of-view of image sensor 350. Furthermore, before providing user 100 with feedback, apparatus 110 may determine whether the object is likely to change its state. If apparatus 110 determines that the object is unlikely to change its state, apparatus 110 may provide a first feedback to user 100. For example, if user 100 points to a road sign, apparatus 110 may provide a first feedback that comprises a descriptor of the road sign. However, if apparatus 110 determines that the object is likely to change its state, apparatus 110 may provide a second feedback to user 100 after the object has changed its state. For example, if user 100 points at a traffic light, the first feedback may comprise a descriptor of the current state of the traffic light (e.g., the traffic light is red) and the second feedback may comprise a descriptor indicating that the state of traffic light has changed (i.e., the traffic light is now green).

Apparatus 110 may also determine that an object that is expected to change its state is not functioning and provide appropriate feedback. For example, apparatus 110 may provide a descriptor indicating that a traffic light is broken.

Apparatus 110 can also assist persons who have low vision by making intelligent decisions regarding a person's intentions. Apparatus 110 can make these decisions by understanding the context of a situation. Accordingly, disclosed embodiments may retrieve contextual information from captured image data and adjust the operation of apparatus 110 based on at least the contextual information. The term “contextual information” (or “context”) refers to any information having a direct or indirect relationship with an object in an environment. In some embodiments, apparatus 110 may retrieve different types of contextual information from captured image data. One type of contextual information is the time and/or the place that an image of the object was captured. Another example of a type of contextual information is the meaning of text written on the object. Other examples of types of contextual information include the identity of an object, the type of the object, the background of the object, the location of the object in the frame, the physical location of the user relative to the object, etc.

In an embodiment, the type of contextual information that is used to adjust the operation of apparatus 110 may vary based on objects identified in the image data and/or the particular user who wears apparatus 110. For example, when apparatus 110 identifies a package of cookies as an object, apparatus 110 may use the location of the package (i.e., at home or at the grocery store) to determine whether or not to read the list of ingredients aloud. Alternatively, when apparatus 110 identifies a signboard identifying arrival times for trains as an object, the location of the sign may not be relevant, but the time that the image was captured may affect the output. For example, if a train is arriving soon, apparatus 110 may read aloud the information regarding the coming train. Accordingly, apparatus 110 may provide different responses depending on contextual information.

Apparatus 110 may use contextual information to determine a processing action to execute or an image resolution of image sensor 350. For example, after identifying the existence of an object, contextual information may be used to determine if the identity of the object should be announced, if text written on the object should be audibly read, if the state of the object should be monitored, or if an image representation of the object should be saved. In some embodiments, apparatus 110 may monitor a plurality of images and obtain contextual information from specific portions of an environment. For example, motionless portions of an environment may provide background information that can be used to identify moving objects in the foreground.

Yet another way apparatus 110 can assist persons who have low vision is by automatically carrying out processing actions after identifying specific objects and/or hand gestures in the field-of-view of image sensor 350. For example, processor 540 may execute several actions after identifying one or more triggers in image data captured by apparatus 110. The term “trigger” includes any information in the image data that may cause apparatus 110 to execute an action. For example, apparatus 110 may detect as a trigger a finger of user 100 pointing to one or more coins. The detection of this gesture may cause apparatus 110 to calculate a sum of the value of the one or more coins. As another example of a trigger, an appearance of an individual wearing a specific uniform (e.g., a policeman, a fireman, a nurse) in the field-of-view of image sensor 350 may cause apparatus 110 to make an audible indication that this particular individual is nearby.

In some embodiments, the trigger identified in the image data may constitute a hand-related trigger. The term “hand-related trigger” refers to a gesture made by, for example, the user's hand, the user's finger, or any pointed object that user 100 can hold (e.g., a cane, a wand, a stick, a rod, etc.).

In other embodiments, the trigger identified in the image data may include an erratic movement of an object caused by user 100. For example, unusual movement of an object can trigger apparatus 110 to take a picture of the object. In addition, each type of trigger may be associated with a different action. For example, when user 100 points to text, apparatus 110 may audibly read the text. As another example, when user 100 erratically moves an object, apparatus 110 may audibly identify the object or store the representation of that object for later identification.

Apparatus 110 may use the same trigger to execute several actions. For example, when user 100 points to text, apparatus 110 may audibly read the text. As another example, when user 100 points to a traffic light, apparatus 110 may monitor the state of the traffic light. As yet another example, when user 100 points to a branded product, apparatus 110 may audibly identify the branded product. Furthermore, in embodiments in which the same trigger is used for executing several actions, apparatus 110 may determine which action to execute based on contextual information retrieved from the image data. In the examples above, wherein the same trigger (pointing to an object) is used, apparatus 110 may use the type of the object (text, a traffic light, a branded product) to determine which action to execute.

To assist user 100 throughout his or her daily activities, apparatus 100 may follow several procedures for saving processing resources and prolonging battery life. For example, apparatus 110 can use several image resolutions to form images. Higher image resolution provides more detailed images, but requires more processing resources. Lower image resolution provides less detailed images, but saves processing resources. Therefore, to prolong battery life, apparatus 110 may have rules for capturing and processing high resolution image under certain circumstances, and rules for capturing and processing low resolution image when possible. For example, apparatus 110 may capture higher resolution images when performing Optical Character Recognition (OCR), and capture low resolution images when searching for a trigger.

One of the common challenges persons with low vision face on a daily basis is reading. Apparatus 110 can assist persons who have low vision by audibly reading text that is present in user 100 environment. Apparatus 110 may capture an image that includes text using sensory unit 120. After capturing the image, to save resources and to process portions of the text that are relevant to user 100, apparatus 110 may initially perform a layout analysis on the text. The term “layout analysis” refers to any process of identifying regions in an image that includes text. For example, layout analysis may detect paragraphs, blocks, zones, logos, titles, captions, footnotes, etc.

In one embodiment, apparatus 110 can select which parts of the image to process, thereby saving processing resources and battery life. For example, apparatus 110 can perform a layout analysis on image data taken at a resolution of one megapixel to identify specific areas of interest within the text. Subsequently, apparatus 110 can instruct image sensor 350 to capture image data at a resolution of five megapixels to recognize the text in the identified areas. In other embodiments, the layout analysis may include initiating at least a partial OCR process on the text.

In another embodiment, apparatus 110 may detect a trigger that identifies a portion of text that is located a distance from a level break in the text. A level break in the text represents any discontinuity of the text (e.g., a beginning of a sentence, a beginning of a paragraph, a beginning of a page, etc.). Detecting this trigger may cause apparatus 110 to read the text aloud from the level break associated with the trigger. For example, user 100 can point to a specific paragraph in a newspaper and apparatus 110 may audibly read the text from the beginning of the paragraph instead of from the beginning of the page.

In addition, apparatus 110 may identify contextual information associated with text and cause the audible presentation of one portion of the text and exclude other portions of the text. For example, when pointing to a food product, apparatus 110 may audibly identify the calorie value of the food product. In other embodiments, contextual information may enable apparatus 110 to construct a specific feedback based on at least data stored in memory 520. For example, the specific feedback may assist user 100 to fill out a form (e.g., by providing user 100 audible instructions and details relevant to a form in the user's field-of-view).

To improve the audible reading capabilities of apparatus 110, processor 540 may use OCR techniques. The term “optical character recognition” includes any method executable by a processor to retrieve machine-editable text from images of text, pictures, graphics, etc. OCR techniques and other document recognition technology typically use a pattern matching process to compare the parts of an image to sample characters on a pixel-by-pixel basis. This process, however, does not work well when encountering new fonts, and when the image is not sharp. Accordingly, apparatus 110 may use an OCR technique that compares a plurality of sets of image regions that are proximate to each other. Apparatus 110 may recognize characters in the image based on statistics relate to the plurality of the sets of image regions. By using the statistics of the plurality of sets of image regions, apparatus 110 can recognize small font characters defined by more than four pixels e.g., six or more pixels. In addition, apparatus 110 may use several images from different perspectives to recognize text on a curved surface. In another embodiment, apparatus 110 can identify in image data an existence of printed information associated with a system command stored in a database and execute the system command thereafter. Examples of a system command include: “enter training mode,” “enter airplane mode,” “backup content,” “update operating system,” etc.

The disclosed OCR techniques may be implemented on various devices and systems and are not limited to use with apparatus 110. For example, the disclosed OCR techniques provide accelerated machine reading of text. In one embodiment, a system is provided for audibly presenting a first part of a text from an image, while recognizing a subsequent part of the text. Accordingly, the subsequent part may be presented immediately upon completion of the presentation of the first part, resulting in a continuous audible presentation of standard text in less than two seconds after initiating OCR.

As is evident from the foregoing, apparatus 110 may provide a wide range of functionality. More specifically, in embodiments consistent with the present disclosure, apparatus 110 may capture image data that includes textual information and non-textual information disposed within a field-of-view of sensory unit 120, detect at least one trigger within the captured image data, identify a level break associated with the detected trigger within the textual information, and perform one or more actions that correspond to the detected trigger within a portion of the textual information associated with the level break.

In certain aspects, “textual information” consistent with the disclosed embodiments may include, but is not limited to, printed text, handwritten text, coded text, text projected onto a corresponding surface, text displayed to a user through a corresponding display screen or touchscreen, and any additional or alternate textual information appropriate to the user and to apparatus 110. Further, the “non-textual information” may include, but is not limited to, images of physical objects, images of persons, images of surroundings, and images of other non-textual objects disposed within the field-of-view of sensory unit 120.

In additional aspects, a “trigger” may include any information within the captured image data that causes apparatus 110 to perform the one or more actions on the corresponding portions of the textual information. For example, such a trigger may be associated with a desire of the user to hear textual information read aloud. In one embodiment, triggers consistent with the disclosed embodiments may include, but are not limited to images of a hand of the user, images of a finger of the user, images of an elongated object capable of being held and pointed by the user (e.g., a cane, a writing implement, a pointer, or a rod), and images of any additional or alternate object or appendage capable of being disposed within a field-of-view of sensory unit 120 by the user. In such instances, at least one of the triggers may correspond to a “pointing” trigger.

In additional embodiments, triggers consistent with the disclosed embodiments may also include images of pre-determined physical objects and individuals disposed within the captured image data. For example, apparatus 110 may be configured to perform one or more actions automatically upon detection of an image of an individual wearing a specific uniform (e.g., a firefighter, emergency medical technician (EMT), a police officer, a member of the military, or a flight attendant) within the captured image data.

Additionally or alternatively, triggers consistent with the disclosed embodiments may include one or images that collectively or individually identify an erratic movement of an object by the user of apparatus 110. For example, the detected trigger may represent one or more images that characterize a waving or shaking motion of a finger, hand, or other elongated object (e.g., a cane, a writing implement, a pointer, or a rod) by the user within a field-of-view of sensory unit 120.

In certain embodiments, at least one of the actions includes a text-based action performed on textual information located within the captured image data. By way of example, such test-based actions include, but are not limited to, optical character recognition (OCR) processes performed on portions of the textual information associated with the detected trigger, processes that generate audible representations of machine-readable text identified and retrieved from the textual information by the OCR processes, and various processes that summarize, process, translate, or store portions of the textual information and/or the machine-readable text.

In one embodiment, apparatus 110 may be configured to perform an action on a portion of the textual information associated with a trigger detected by apparatus 110 within captured image data. By way of example, the detected trigger may be associated with a position within the textual information, and as such, with an intermediate portion of the textual information disposed proximate to a “level break” within the textual information. In certain aspects, the term “level break” may refer to any discontinuity within the textual information, which includes, but is not limited to, a beginning or end of a sentence within the textual information, a beginning or end of a paragraph within the textual information, a beginning or end of a page of the textual information, and a beginning or end of a column of the textual information.

In such instances, the portion of the textual information associated with the detected trigger may be identified based on the level break. For example, the portion of the textual information associated with the detected trigger may corresponding to textual information disposed subsequent to the corresponding level break within the captured image data, prior to the corresponding level break within the captured image data, and/or disposed between the corresponding level break and one or more additional discontinuities within the textual data.

In an embodiment, apparatus 110 may include a memory (e.g., memory 520) configured to store one or more applications and application modules that, when executed by a processor (e.g., processor 540), enable processor 540 to identify and perform at least one action based on a detection of one or more triggers within captured image data. In certain aspects, memory 520 may also be configured to store the captured image data and information associated with the captured image data. Additionally, memory 520 may store information that identifies one or more actions and further, information that links the one or more actions to corresponding triggers detectable by processor 540 within the captured image data. FIG. 6 illustrates an exemplary structure of memory 520, in accordance with disclosed embodiments.

In FIG. 6, memory 520 may be configured to store an image data storage module 602, an image processing module 604, and an image database 622. In one embodiment, image data storage module 602, upon execution by processor 540, may enable processor 540 to receive data corresponding to one or more images captured by sensory unit 120, and to store the captured image data within image database 622. In some aspects, the captured image data may include textual information (e.g., printed, handwritten, coded, projected, and/or displayed text) and non-textual information (e.g., images of physical objects, persons, and/or triggers), and processor 540 may store the image data in image database 622 with additional data specifying a time and/or date at which sensory unit 120 captured the image data. In additional embodiments, image data storage module 602 may further enable processor 540 to configure wireless transceiver 530 to transmit the captured image data to one or more devices (e.g., an external data repository or a user's mobile device) in communication with apparatus 110 across a corresponding wired or wireless network.

In an embodiment, image processing module 604, upon execution by processor 540, may enable processor 540 to process the captured image data and identify elements of textual information within the captured image data. In certain aspects, textual information consistent with the disclosed embodiments may include, but is not limited to, printed text (e.g., text disposed on a page of a newspaper, magazine, book), handwritten text, coded text, text displayed to a user through a display unit of a corresponding device (e.g., an electronic book, a television a web page, or an screen of a mobile application), text disposed on a flat or curved surface of an object within a field-of-view of apparatus 110 (e.g., a billboard sign, a street sign, text displayed on product packaging), text projected onto a corresponding screen (e.g., during presentation of a movie at a theater), and any additional or alternate text disposed within images captured by sensory unit 120.

In certain aspects, upon execution of image processing module 604, processor 540 may perform a layout analysis of the image data to identify textual information within the captured image data. By way of example, processor 540 may perform a layout analysis to detect paragraphs of text, blocks of text, zones and/or regions that include text, logos, titles, captions, footnotes, and any additional or alternate portions of the image data that includes printed, handwritten, displayed, coded, and/or projected text.

Memory 540 may also be configured to store a trigger detection module 606 and a trigger database 624. In one embodiment, trigger detection module 606 may, upon execution by processor 540, enable processor 540 to detect an existence of a trigger within the captured image data. In certain aspects, as described above, processor 540 may identify textual information within the captured data, and may execute trigger detection module 606 to identify an existence of the trigger within the textual information. By way of example, processor 540 may access trigger database 624 to obtain information identifying one or more candidate triggers, and processor 540 may leverage the candidate trigger information to detect the trigger within the captured image data.

In certain aspects, and as described above, the detected trigger may correspond to any information within the captured image data that causes apparatus 110 to perform one or more actions. By way of example, triggers consistent with the disclosed embodiments may include, but are not limited to, an image of a hand of the user, an image of a finger of the user, an image of an elongated object capable of being held and pointed by the user (e.g., a cane, a writing implement, a pointer, or a rod), and an image of any additional or alternate object or appendage capable of being disposed within a field-of-view of sensory unit 120 by the user.

Additionally or alternatively, triggers consistent with the disclosed embodiments may also include images of pre-determined physical objects and specific individuals in uniform (e.g., a firefighter, emergency medical technician (EMT), a police officer, a member of the military, or a flight attendant). In additional aspects, triggers consistent with the disclosed embodiments may include one or more images that collectively or individually identify an erratic movement of an object by the user of apparatus 110. For example, the detected trigger may represent one or more images that characterize a waving or shaking motion of a finger, hand, or other elongated object (e.g., a cane, a writing implement, a pointer, or a rod) by the user within a field-of-view of sensory unit 120.

Referring back to FIG. 6, memory 520 may also be configured to store a level break identification module 608. In an embodiment, level break identification module 608 may, upon execution by processor 540, enable processor 540 to identify a level break that corresponds to the detected trigger. For example, a “level break” may represent any of a number of discontinuities within the textual information of the captured image data, which include, but are not limited to, a beginning or end of a sentence within the textual information, a beginning or end of a paragraph within the textual information, a beginning or end of a page of the textual information, and a beginning or end of a column of the textual information.

In certain aspects, the detected trigger may be associated with an intermediate portion of the textual information. By way of example, “intermediate portions” consistent with the disclosed embodiments may include, but are not limited to, a portion of a sentence disposed within the textual information, a portion of a paragraph disposed within the textual information, a portion of a page of the textual information, and a portion of a column of the textual information.

In certain embodiments, and upon execution of level break detection module 608, processor 540 may assign a level break to the detected trigger based on the intermediate portion associated with the detected trigger. By way of example, if the determined intermediate portion falls within a particular paragraph of the textual information, processor 540 may identify a starting position of a successive paragraph as the level break for the detected trigger.

Additionally or alternatively, processor 540 may execute level break identification module 608 to identify a discontinuity within the textual information disposed proximate to the intermediate portion as the level break for the detected trigger. For example, processor 540 may compute displacements between the identified level breaks and the intermediate portion of the detected trigger, and may assign the level break associated with a minimum of the displacements to the detected trigger.

Further, in an embodiment, the intermediate portion of the detected trigger may be disposed equidistant between two of the identified level breaks within the textual information. In such an instance, processor 540 may obtain contextual information associated with a user of apparatus 110 to determine which of the equidistant level breaks should be assigned to the detected trigger. By way of example, the contextual information may include information identifying a history of prior relationships between detected triggers and selected level breaks, prior documents browsed by the user, and any additional or alternate information appropriate to the user and to the captured image data.

Image data storage module 602, image processing module 604, trigger detection module 606, level break identification module 608, action identification module 610, action performance module 612, OCR module 614, and audible representation module 616 may be implemented in software, hardware, firmware, a mix of any of those, or the like. For example, if the modules are implemented in software, they may be stored in memory 520, as shown in FIG. 6. Other components of processing unit 140 and/or sensory unit 120 may be configured to perform processes to implement and facilitate operations of image data storage module 602, image processing module 604, trigger detection module 606, level break identification module 608, action identification module 610, action performance module 612, OCR module 614, and audible representation module 616. Thus, image data storage module 602, image processing module 604, trigger detection module 606, level break identification module 608, action identification module 610, action performance module 612, OCR module 614, and audible representation module 616 may include software, hardware, or firmware instructions (or a combination thereof) executable by one or more processors (e.g., processor 540), alone or in various combinations with each other. For example, the modules may be configured to interact with each other and/or other modules of apparatus 110 to perform functions consistent with disclosed embodiments. In some embodiments, any of the disclosed modules (e.g., image data storage module 602, image processing module 604, trigger detection module 606, level break identification module 608, action identification module 610, action performance module 612, OCR module 614, and audible representation module 616) may each include dedicated sensors (e.g., IR, image sensors, etc.) and/or dedicated application processing devices to perform the functionality associated with each module.

FIGS. 7A-7F illustrate exemplary level breaks disposed within corresponding textual information, according to disclosed embodiments. By way of example, as illustrated in FIG. 7A, a user of apparatus 110 may view a page 700 of a printed newspaper, and may position a finger or other elongated object (e.g., a cane, a pointer, or a writing instrument) over a portion of the printed newspaper to serve as a trigger. Apparatus 110 may capture an image that includes a portion 702 of page 700 and an image 704 of the finger or other elongated object.

As described above, processor 540 may execute image processor module 604 to identify textual information within the captured image data, and further, may execute trigger detection module to detect an image of the trigger (e.g., image 704) and identify an intermediate portion of the textual information that corresponds to image 704. For example, as illustrated in FIG. 7B, the captured image data may include a single column of text that includes paragraphs 712 and 722, and the detected trigger (not shown) may be associated with an intermediate portion 706 disposed within paragraph 712. In one embodiment, processor 540 may, upon execution of level break identification module 608, identify a discontinuity 732 corresponding to a starting position of paragraph 722, and select discontinuity 732 as a level break associated with the detected trigger.

The disclosed embodiments are, however, not limited to the selection of level breaks that correspond to starting positions within subsequent paragraphs. For example, as illustrated in FIG. 7C, processor 540 may execute level break identification module 608 to identify discontinuities 734A and 734B that correspond to a starting position and ending position of paragraph 712. Depending on displacements between intermediate portion 706 and corresponding ones of discontinuities 734A and 734B, processor 540 may select one of discontinuities 734A and 734B as the level break associated with the detected trigger. For example, processor 540 may select as the level break a corresponding one of discontinuities 734A and 734B associated with a minimum of the displacements.

In other embodiments, illustrated in FIG. 7D, processor 540 may determine that intermediate portion 706 is disposed within a sentence 712A of paragraph 712. Processor 540 may execute level break identification module 608 to identify discontinuities 736A and 736B that correspond to a starting position and ending position of sentence 712A within paragraph 712. As described above, processor 540 may select one of discontinuities 736A and 736B as the level break associated with the detected trigger.

Further, in some embodiments, processor 540 may select level breaks that correspond to discontinuities located at a beginning or end of a page of the textual information. As illustrated in FIG. 7E, processor 540 may execute level break identification module 608 to identify discontinuities 738A and 738B located at a beginning of page 700 and at an end of page 700. In such instances, processor 540 may select one or discontinuities 738A and 738B as the level break associated with the detected trigger.

Further, in additional embodiments, the captured image data may include textual information disposed within two or more columns on page 700. For example, as illustrated in FIG. 7F, the captured image data may include columns 742 and 744 of text disposed side-by-side along a longitudinal axis of page 700, and the detected trigger (not shown) may be associated with intermediate portion 706 disposed within column 742. Processor 540 may execute level break identification module 608 to identify discontinuities 752A and 752B located at a beginning of column 742 and at an end of column 742. In such instances, processor 540 may select one or discontinuities 752A and 752B as the level break associated with the detected trigger.

Referring back to FIG. 6, memory 520 may also be configured to store an action identification module 610 and an action database 626. In an embodiment, action database 626 may be configured to store action information that identifies one or more actions, and further, links the actions to corresponding triggers. In one aspect, the action information may link a trigger to a single action to be performed by processor 540. In other aspects, however, the action information may link a plurality of discrete actions to a corresponding one of the triggers, and further, may identify a sequence in which processor 540 may perform the plurality of discrete actions in response to a detection of the corresponding trigger within the captured image data.

As described above, actions consistent with the disclosed embodiments may include text-based actions performed on textual information located within the captured image data. By way of example, such test-based actions include, but are not limited to, optical character recognition (OCR) processes performed on textual information associated with the detected trigger, processes that generate audible representations of machine-readable text identified and retrieved from the textual information by the OCR processes, and various processes that summarize, process, translate, or store portions of the textual information and/or the machine-readable text.

Further, upon execution of action identification module 610, processor 540 may identify an action that corresponds to a trigger detected within the captured image date (e.g., as detected through the execution of trigger detection module 606). In certain aspects, processor 540 may, upon execution of action identification module 610, access action database 626 and obtain action information linking the detected trigger to one or more corresponding actions. Based on the obtained action information, processor 540 may identify the action corresponding to the detected trigger.

Memory 520 may further be configured to store an action performance module 612, an optical character recognition (OCR) module 614, and an audible representation generation module 616. As described above, processor 540 may execute level break identification module 608 to identify a level break within the textual information, and may execute action identification module 610 to identify one or more actions that correspond to the detected trigger. In an embodiment, action performance module 612 may, upon execution by processor 540, enable processor 540 to initiate a performance of the one or more identified actions on a portion of the textual information located proximate to the identified level break. By way of example, and as described above, actions consistent with the disclosed embodiments include, but are not limited to, optical character recognition (OCR) processes that identify and retrieve machine-readable text from the textual information, processes that generate audible representations of machine-readable text, and various processes that summarize, process, translate, or store portions of the textual information and/or the machine-readable text.

In an embodiment, OCR module 614 may, upon execution by processor 540, enable processor 540 to perform one or more OCR processes on the textual information. By way of example, processor 540 may execute OCR module 606, either independently or in conjunction with action performance module 612, to identify and retrieve machine-readable text from portions of the textual information disposed prior to or subsequent to the identified level break.

Audible representation generation module 606 may, upon execution by processor 540, enable processor 540 to generate an audible representation of at least a portion of the machine-readable text, which apparatus 110 may present to the user through a speaker or a bone conduction headphone associated with processing unit 140. In an embodiment, processor 540 may execute OCR module 614 and audible representation generation module 616 sequentially such that processor 540 generates the audible representation of the machine-readable text upon completion of the OCR processes performed by OCR module 614.

In additional embodiments, processor 540 may execute of audible representation generation module 616 at a pre-determined time (e.g., one second, three second, or four seconds) after executing OCR module 614. In such instances, processor 540 may be configured to generate and present to the user an audible representation of an initial portion of machine-readable text while concurrently executing OCR module 614 to identify and retrieve subsequent portions of machine-readable text.

Further, in certain embodiments, processor 540 may selectively suspend and resume a performance of an action in response to more pre-determined actions taken by a user of apparatus 110. In one aspect, processor 540 may suspend the performance of the action on the textual information (e.g., an audible presentation of machine-readable text corresponding to the textual information) when the user looks away from the textual information. For example, during performance of the identified action, sensory unit 120 may continue to capture image data within a corresponding field-of-view, and may continuously provide the captured image data to processing unit 140 for storage within image database 622.

In one aspect, and upon execution of action performance module 612, processor 540 may monitor the newly-received captured image data to determine whether the user looks away from the textual information (e.g., through a corresponding change in the field-of-view of sensory unit 120). If processor 540 determines that the user no longer views at least a portion of the textual information, processor 540 may suspend the performance of the action (e.g., the audible presentation) and identify a position within the textual information that corresponds to the suspension (e.g., a stopping point). In certain embodiments, processor 540 may continue to monitor the captured image data to determine whether the user looks back to the textual information. If the user looks back to the textual information, processor 540 may resume the performance of the identified action (e.g., the presentation of the audible representation) from the identified stopping point.

In additional embodiments, processor 540 may suspend a performance of an identified action in response to a detection of an additional trigger within the captured image data. By way of example, as described above, processor 540 may execute various software modules to identify a first trigger within the captured image data, identify a first level break associated with the first trigger, and identify and perform a first action that corresponds to the first trigger on a portion of the textual information corresponding to the first level break. In certain aspects, processor 540 may continue to monitor image data captured by sensory unit 120 while performing the first action, and may detect an existence of a second trigger within the newly captured image data. Upon detection of the second trigger, processor 504 may suspend a performance of the first action, and may identify a second level break and a second action that corresponds to the second trigger. Processor 540 may perform the second action on a portion of the textual information corresponding to the second level break.

In other embodiments, image database 622, trigger database 624, and/or action database 626 may be located remotely from memory 520, and be accessible to other components of apparatus 110 (e.g., processing unit 140) via one or more wireless connections (e.g., a wireless network). While multiple databases are shown, it should be understood that image database 622, trigger database 624, and action database 626 may be combined and/or interconnected databases may make up the databases. Image database 622, trigger database 624, and/or action database 626 may further include computing components (e.g., database management system, database server, etc.) configured to receive and process requests for data stored in associated memory devices.

FIG. 8 is a flow diagram of an exemplary process 800 for identifying and performing actions on captured image data, according to disclosed embodiments. As described above, sensory unit 120 may capture image data that includes textual information and non-textual information disposed within a corresponding field-of-view. Processing unit 130 may receive the captured image data, and processor 540 may execute one or more application modules to detect a trigger within the captured data, identify one or more actions associated with the detected trigger, and initiate a performance of the one or more actions on the textual information within the captured image data. Process 800 provides further details on how processor 540 identifies and performs one or more actions based on triggers included within the captured image data.

In step 802, processor 540 may obtain captured image data. In some aspects, sensory unit 120 may capture one or more images, and the captured image data may be transmitted to processing unit 140 across wired or wireless communications link 130. Processor 540 may, in step 802, obtain the captured image data directly from sensory module 120 across communications link 130, or alternatively, processor 540 may retrieve the captured image data from a corresponding data repository (e.g., image database 622 of memory 540). By way of example, the captured image data may include one or more regions of printed, displayed, or projected information.

In step 804, processor 540 may analyze the captured image data to identify the textual information. As described above, the textual information may include, but is not limited to, printed, handwritten, projected, coded, or displayed text, and processor 540 may perform a layout analysis to detect the textual information within the captured image data. By way of example, the detected textual information may include, but are not limited to, paragraphs of text, blocks of text, regions and/or zones that include text, logos, titles, captions, footnotes, and any additional or alternate portions of the captured image data that includes printed, handwritten, displayed, coded, and/or projected text.

In step 806, processor 540 may leverage image processing techniques to detect an image of a trigger within the captured image data. In certain aspects, and as described above, the detected trigger may include, but is not limited to an image of a hand of a user of apparatus 110, an image of a finger of the user, an image of an elongated object capable of being held and pointed by the user (e.g., a cane, a writing implement, a pointer, or a rod), and images of any additional or alternate object or appendage capable of being disposed within a field-of-view of sensory unit 120 by the user. In additional aspects, triggers consistent with the disclosed embodiments may also include an image of a pre-determined physical object, an image of a specific individual in uniform (e.g., a firefighter, emergency medical technician (EMT), a police officer, a member of the military, or a flight attendant), and additionally or alternatively, a collection of images that identify an erratic movement of an object by the user.

Processor 540 may also identify an intermediate portion within the textual information that corresponds to the detected trigger in step 806. In certain aspects, the intermediate portion may be disposed within a structured element of the textual information, such as a sentence, a paragraph, a page, or a column of textual information. Further, in some aspects, the intermediate portion corresponding to the detected trigger may be associated with a corresponding position within the captured image data.

Referring back to FIG. 8, in step 808, processor 540 may identify a level break that corresponds to the detected trigger. As described above, the identified level break may represent any of a number of discontinuities within the identified textual information, which include, but are not limited to, a beginning or end of a sentence within the textual information, a beginning or end of a paragraph within the textual information, a beginning or end of a page of the textual information, and a beginning or end of a column of the textual information.

In one embodiment, processor 540 may analyze the identified textual information to identify a plurality of discontinuities, and may select one of the discontinuities as the level break in step 808 based on a relationship between the selected discontinuity and the intermediate portion corresponding to the detected trigger. For example, processor 540 may select one of the identified discontinuities disposed proximate to the intermediate portion as the level break in step 808. Additionally or alternatively, processor 540 may compute displacements between the identified discontinuities and the position associated with the intermediate portion in step 808, and may select that discontinuity associated with a minimum of the displacements as the level break.

Additionally or alternatively, processor 540 may determine in step 808 that the intermediate portion falls within a particular paragraph of the textual information. In such an instance, processor 540 may select a starting position of a subsequent paragraph as the level break associated with detected trigger. Further, processor 540 may determine in step 808 that the intermediate portion falls within a particular sentence of the textual information, and may select a starting position of a subsequent sentence as the level break associated with detected trigger.

In some embodiments, processor 540 may determine that the intermediate portion falls equidistant between two discontinuities within the textual information. In certain embodiments, processor 540 may obtain contextual information related to one or more of the user of apparatus 110 or an object or document associated with the captured image data to infer the user's intentions and select a corresponding one of the discontinuities as the level break. By way of example, the contextual information may include information identifying a history of prior relationships between detected triggers and selected level breaks, prior documents browsed by the user, and any additional or alternate information appropriate to the user and to the captured image data.

Referring back to FIG. 8, processor 540 may identify one or more actions that correspond to the detected trigger in step 810. In some aspects, as described above, processor 540 may access a corresponding data repository (e.g., action database 626 of memory 520) to obtain action information that links the detected trigger to at least one predetermined action. Processor 540 may, in such instances, identify the one or more actions based on the obtained action information.

In an embodiment, the obtained information may link the detected trigger to a single action, which processor 540 may identify in step 810. In other embodiments, the obtained action information may link the detected trigger to a plurality of discrete actions. By way of example, the obtained action information may link the detected trigger to a first process (e.g., an OCR process) and to a second process (e.g., a process that generates and presents an audible representation of machine-readable text to a user of apparatus 110). Further, the obtained action information may indicate an order in which processor 540 should execute the plurality of discrete actions. For example, in step 810, processor 540 may determine that the detected trigger is associated with a first action and a second action that should be executed at a predetermined after an execution of the first action (e.g., a process that generates an audible representation should be executed by processor 540 at a predetermined time after executing an OCR process).

In certain aspects, actions consistent with the disclosed embodiments include various OCR processes, processes that generate an audible representation of portions of machine-readable text (e.g., as identified and retrieved by one or more of the OCR processes), and processes that present the audible representation to the user. In additional aspects, actions consistent with the disclosed embodiments may include other text-based actions, such as processes that summarize, process, translate, or store portions of the textual information and/or the machine-readable text.

In further embodiments, processor 540 may identify at least one action in step 810 that corresponds to a manipulation of portions of machine-readable text. For example, a detected trigger may be associated with a first OCR process that retrieves text corresponding to denominations of paper currently, and a second process that computes a sum of the various denominations, which may be audibly presented to a user of apparatus 110.

In step 812, processor 540 may identify a portion of the textual information associated with the identified level break (e.g., the level break associated with the detected trigger), and perform the one or more actions on the identified portion of the textual information. In an embodiment, the identified portion of the textual information may be disposed subsequent to the identified level break within the document or object associated with the captured image data. For example, the level break may correspond to a starting position of a paragraph within a page of textual information, and the portion of the textual information identified by processor 540 may include textual information disposed below the level break on the page. The disclosed embodiments are, however, not limited to portions of textual information disposed subsequent to a level break, and in additional embodiments, processor 540 may perform the one or more actions on portions of textual information disposed above the level break, or located at positions within the captured image data having any relation to the level break appropriate to the captured image data and the one or more actions. Upon performance of the one or more actions in step 812, exemplary process 800 is complete.

In some embodiments, as described above, processor 540 may identify a plurality of actions linked to the detected trigger. For example, processor 540 may determine in step 810 that the detected trigger is linked to a first action that includes an OCR process, and a second action that includes a process for generating and presenting an audible representation of machine-readable text. In certain aspects, as described below in reference to FIG. 9, processor 540 may initiate and execution of the OCR process, and subsequently execute the process for generating and presenting the audible representation at a predetermined time after executing the OCR process, but prior to a completion of the OCR process. In such instances, processor 540 may cause apparatus 110 to present the audible representation of an initial portion of machine-readable text while the executed OCR process continues to identify and retrieve subsequent portions of machine-readable text.

FIG. 9 is a flow diagram of an exemplary process 900 for performing multiple actions based on captured image data, according to disclosed embodiments. As described above, processor 540 may detect a trigger within captured image data (e.g., step 806 of FIG. 8), may identify a level break corresponding to the detected trigger (e.g., step 808 of FIG. 8), and may identify and perform one or more actions that correspond to the detected trigger within a portion of textual information associated with the level break (e.g., steps 808 and 810 of FIG. 8). In certain embodiments, the one or more actions may include a first action corresponding to an OCR process and a second action corresponding to a process that generates and presents an audible representation of machine-readable text to a user of apparatus 110. Process 900 provides further details on how processor 540 performs an OCR process, which identifies and retrieves machine-readable text from textual information, concurrently with a process that generates and presents an audible representation of the machine-readable text to the user.

In step 902, processor 540 may perform an OCR process on textual information included within captured image data to identify and retrieve machine-readable text. As described above, sensory unit 120 may capture one or more images, and the captured image data may be transmitted to processing unit 140 across wired or wireless communications link 130. Processor 540 may obtain the captured image data (e.g., step 802 of FIG. 8) may analyze the captured image data to identify portions of the captured image data that include the textual information (e.g., step 804 of FIG. 8), may detect an image of a trigger within the captured image data (e.g., step 806 of FIG. 8), and may identify a level break within the textual information that corresponds to the detected trigger (e.g., step 808 of FIG. 8). In such embodiments, processor 540 may perform the OCR process on a portion of the textual information that is associated with the identified level break (e.g., textual information disposed below the level break within the captured image data).

In step 904, processor 540 may generate an audible representation of at least a portion of the machine-readable text identified and retrieved by the executed OCR process, and configure apparatus 110 to present the generated audible representation to the user through a speaker or a bone conduction headphone associated with processing unit 140. In one embodiment, processor 540 may initiate the presentation of the audible representation in step 904 prior to completing the OCR process initiated in step 902. In such instances, processor 540 may identify and retrieve machine-readable text from a subset of the textual information associated with the identified level break before causing apparatus 110 to present the audible representation to the user.

In certain aspects, processor 540 may cause apparatus 110 to present the generated audible presentation in step 904 within a predetermined time period after initiating the OCR process in step 902. By way of example, predetermined time periods consistent with the disclosed embodiments may include, but are not to, one second, three second, and four seconds.

In step 906, processor 540 may determine whether the OCR process initiated in step 902 is complete (e.g., that processor 540 identified and retrieved machine-readable text from the entire identified portion of the textual information). If processor 504 determine that the OCR process is incomplete (e.g., step 906; NO), then processor 540 may continue to perform the OCR process on the textual information associated with the identified level break. In such an instance, processor 540 may cause apparatus 110 to present an audible representation of an initial portion of machine-readable text while concurrently executing the OCR process to identify and retrieve addition portions of machine-readable text.

If, however, processor 540 determines that the OCR process is complete (e.g., step 906; YES), processor 540 may determine in step 908 whether apparatus 110 completes the audible presentation of the machine-readable text (e.g., that processor 540 caused apparatus 110 to present an audible representation of the machine-readable text in its entirety). If processor 540 determines that the audible presentation is incomplete (e.g., step 908; NO), processor 540 may cause the processor to continue presenting the audible representation of the machine-readable text in step 904.

Alternatively, if processor 540 determines that apparatus 110 completed the audible presentation of the machine-readable text (e.g., step 908; YES), processor 540 determines in step 910 whether additional textual information requires OCR processing. If processor 540 determines that no additional portions of the textual information require OCR processing (e.g., step 910; NO), then exemplary process 900 is complete.

If, however, processor 540 determines that additional textual information requires OCR processing (e.g., step 910; YES), then processor 540 may identify one or more additional portions of the textual information for processing in step 912. In some embodiments, processor 540 may select the additional portions of the textual information in step 912 based on one or more portions of the previously retrieved machine-readable text.

In certain aspects, processor 540 may associate the identified level break with several paragraphs may be disposed below the level break within the textual information, and processor 540 may have performed the OCR processor on only a subset of the paragraphs in step 902. In such an instance, processor 540 may determine that additional textual information require OCR processing in step 910, and may select one or more of the remaining paragraphs associated with the level break for OCR processing in step 912. Upon selection of the additional portions of the textual information in step 912, exemplary process 900 passes back to step 902, and processor 540 performs the OCR process on the selected additional portions of the textual information, as described above.

Using the disclosed embodiments, processor 540 may detect a trigger within captured image data, identify textual information within the captured image data that is associated with the detected trigger, and automatically identify and perform one or more actions corresponding to the detected trigger on the identified textual information. For example, a user of apparatus 110 may point to a particular paragraph within a first newspaper article, and processor 540 may perform an OCR process to identify and retrieve machine-readable text within the first newspaper article, and cause apparatus 110 to present an audible representation of the machine-readable text to the user.

During the audible presentation of the machine-readable text, processor 540 may receive and analyze data corresponding to one or more additional images captured by sensory unit 120. At some point during the audible presentation, processor 540 may detect an additional trigger within the captured image data. For example, the user may look at an additional article within the newspaper, and may point to a headline associated with the additional article. In such instances, processor 540 may suspend the audible presentation, may initiate a second OCR process to identify and retrieve machine-readable text from the additional newspaper article, and may cause apparatus 110 to begin an audible presentation of the newly retrieved machine-readable text.

FIG. 10 illustrates an exemplary process 1000 for adaptively performing actions on textual information within captured image data, according to disclosed embodiments. As described above, sensory unit 120 may capture image data that includes textual information and non-textual information disposed within a corresponding field-of-view. Processing unit 140 may receive the captured image data, and processor 540 may execute one or more application modules to identify textual information within the captured image data (e.g., step 804 of FIG. 8), detect a first trigger within the captured image data (e.g., step 806 of FIG. 8), identify a first level break within the textual information based on the detected trigger (e.g., step 808 of FIG. 8), and perform one or more first actions that correspond to the detected trigger within a first portion of textual information associated with the first level break (e.g., steps 810 and 812 of FIG. 8). Process 1000 provides further details on how processor 540 identifies and performs one or more second actions on a second portion of the textual information in response to a detection of a second trigger within the captured image data.

In step 1002, processor 540 may perform the one or more first actions on the first portion of the textual information. As described above, processor 540 may detect an existence of the first trigger within the textual information of the captured image data. Based on a first intermediate portion of detected first trigger within the textual information, processor 540 may identify the first level break, which may be associated with the corresponding first portion of the textual information. Further, and as described above, processor 540 may access a corresponding data repository (e.g., action database 626), and obtain action information that may enable processor 540 to identify the one or more first actions based on an association with the detected first trigger.

In an embodiment, the one or more first actions may include an OCR process performed on the first portion of the textual information to identify and retrieve machine-readable text, and a process that generates and causes apparatus 110 to present to a user an audible representation of at least a portion of the machine-readable text. The disclosed embodiments are, however, not limited to such exemplary actions, and in further embodiments, at least one of the first actions may include, but is not limited to, actions that summarize, process, translate, manipulate, or store portions of the machine-readable text.

As described above, processor 540 may receive and analyze additional image data captured by sensory unit 120 during a performance of the one or more first actions in step 1004. In step 1004, processor 540 may detect an existence of a second trigger within the additional captured image data, and further, may determine a second intermediate portion within textual information of the additional captured image data that corresponds to the detected second trigger.

In certain aspects, and as described above, the detected second trigger may include, but is not limited to an image of a hand of a user of apparatus 110, an image of a finger of the user, an image of an elongated object capable of being held and pointed by the user (e.g., a cane, a writing implement, a pointer, or a rod), and images of any additional or alternate object or appendage capable of being disposed within a field-of-view of sensory unit 120 by the user. In additional aspects, second triggers consistent with the disclosed embodiments may also include an image of a pre-determined physical object, an image of a specific individual in uniform (e.g., a firefighter, emergency medical technician (EMT), a police officer, a member of the military, or a flight attendant), and additionally or alternatively, a collection of images that identify an erratic movement of an object by the user.

In step 1008, and as similarly described above in reference to step 808 of FIG. 8, processor 540 may identify a second level break within the textual information corresponding to the detected second trigger. As described above, the identified level break may represent any of a number of discontinuities within the identified textual information, which include, but are not limited to, a beginning or end of a sentence within the textual information, a beginning or end of a paragraph within the textual information, a beginning or end of a page of the textual information, and a beginning or end of a column of the textual information.

In step 1010, processor 540 may identify one or more second actions that correspond to the detected second trigger. By way of example, and as described above in reference step 810 of FIG. 8, processor 540 may access a corresponding data repository (e.g., action database 626 of memory 520), and obtain action information that links the detected second trigger to at least one predetermined actions. Processor 540 may then identify the one or more second actions based on the obtained action information.

In step 1012, processor 540 may perform the one or more second actions on a second portion of the textual information that corresponds to the identified second level break. As described above, the second portion of the textual information may be disposed subsequent to the identified second level break within the document or object associated with the captured image data. Upon completion of the one or more second actions, exemplary process 100 is complete.

In some aspects, the first and second actions may include actions that perform an OCR process on corresponding portions of textual information to identify and retrieve machine-readable text, actions that generate audible presentations of portions of the retrieved machine-readable text, and actions that cause processor 110 to present corresponding ones of the audible representation to a user. The disclosed embodiments are not limited to such exemplary actions, and in further embodiments, one or more of the first and second actions may include various processes that summarize, process, translate, manipulate, or store portions of the machine-readable text, as described above. For example, in one embodiment, processor 540 may select at least one of the second actions based on an output of at least one of the first actions (e.g., one or more portions of machine-readable text retrieved by an OCR process).

Further, in an embodiment, the one or more first actions may include a single first action associated with the detected first trigger, and the one or more second actions may include a single second action associated with the detected second trigger. In some aspects, the single first and second action may represent a common action, such as an OCR process that retrieves machine-readable text from corresponding portions of textual information. In alternate embodiments, the first and second actions may include different actions performed on different portions of the textual information within the captured image data. By way of example, the first action may include a process that presents an audible representation of machine-readable text from a first portion of textual information to a user, and the second action may include an OCR process that retrieves machine-readable text from a second portion of the textual information in anticipation of audible presentation.

Using the embodiments described above, processor 540 may suspend a performance of an action associated with a detected first trigger upon detection of a second trigger within the captured image data. The disclosed embodiments are, however, not limited to techniques that suspend a performance of an action in response to a detected trigger. In additional embodiments, described below in reference to FIG. 11, processor 540 may selectively suspend and resume a performance of an action based various activities of a user of apparatus 110.

FIG. 11 illustrates an exemplary process 1100 for selectively suspending a performance of actions based on detected user behavior, according to disclosed embodiments. As described above, sensory unit 120 may capture image data that includes textual information and non-textual information disposed within a corresponding field-of-view. Processing unit 130 may receive the captured image data, and processor 540 may execute one or more application modules to identify textual information within the captured image data (e.g., step 804 of FIG. 8), detect a trigger within the captured image data (e.g., step 806 of FIG. 8), and identify a level break within the textual information based on the detected trigger (e.g., step 808 of FIG. 8). Process 1100 provides further details on how processor 540 selectively suspends and resumes a performance of an action based on detected user activity.

In step 1102, processor 540 may perform an action that corresponds to the detected trigger within a portion of textual information associated with the level break. As described above, the level break may represent a discontinuity within the textual information, and processor 540 may identify the level break based on an associated with the detected trigger, and additionally or alternatively, a proximity of the level break to a position within the captured image data associated with the detected trigger.

In an embodiment, in step 1102, processor 540 may cause apparatus 110 to provide to a user an audible representation of machine-readable text retrieved from the portion of the textual information. In certain aspects, apparatus 110 may provide the audible representation to the user through a speaker or a bone conduction headphone associated with processing unit 140. The disclosed embodiments are, however, not limited to such exemplary actions, and in additional embodiments, the action performed by processor 540 in step 1102 may include, but is not limited to, an OCR process and various processes that summarize, process, translate, manipulate, or store portions of machine-readable text.

As described above, sensory unit 120 may continue to capture image data within a corresponding field-of-view during the audible presentation. In certain aspects, sensory unit 112 may continuously provide the captured image data to processing unit 140 for storage within image database 622, and processor 540 may monitor the newly-received captured image data. For example, processor 540 may analyze the newly-captured image data upon receipt from sensory unit 120, or alternatively, may access image database 622 to obtain and analyze portions of the newly-captured image data.

In step 1104, processor 540 may determine whether the user looks away from the portion of the textual information based on a corresponding change in the field-of-view of sensory unit 120. If processor 540 that the user continues to view the portion of the textual information (e.g., step 1104; NO), processor 540 may continue to perform the action on the portion of the textual information in step 1102. For example, processor 540 may continue to cause apparatus 110 to provide the audible representation to the user.

If, however, processor 540 determines that the user no longer views the portion of the textual information (e.g., step 1104; YES), processor 540 may suspend a performance of the action in step 1106, and may identify a position within the textual information that corresponds to suspension of the performance (e.g., a “stopping point”) in step 1108. By way of example, if the user looks away from the textual information, processor 540 may suspend the audible presentation at a corresponding stopping point within the textual information.

In step 1110, processor 540 may continue to monitor the newly-captured image data, and in step 1112, processor 540 may determine whether the user resumes viewing the portion of the textual information. In certain aspects, processor 540 may determine that the user resumes viewing the portion of the textual information based on a change in the field-of-view of sensory unit 120.

If processor 540 determine that the user does not resume viewing the textual information (e.g., step 1112; NO), processor 540 may continue to monitor the newly captured image data in step 1110 for changes in the field-of-view of sensory unit 120. Alternatively, if processor 540 determines that the user resumed viewing the portion of the textual information (e.g., step 1112; YES), processor 540 may resume the performance of the suspended action from the identified stopping point. By way of example, in step 1112, processor 540 may resume the suspended audible presentation from the identified stopping point within the textual information. Exemplary process 1100 then ends.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks, floppy disks, or CD ROM, or other forms of RAM or ROM, USB media, DVD, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets. One or more of such software sections or modules can be integrated into a computer system or existing e-mail or browser software.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed routines may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. An apparatus for audibly reading text retrieved from a captured image, the apparatus comprising:
an image sensor configured to capture image data from an environment of a user;
at least one processor device configured to:
determine an existence of a trigger in the image data, the trigger being associated with a desire of the user to hear text read aloud, and wherein the trigger identifies an intermediate portion of the text a distance from a level break in the text;
perform a layout analysis on the text to identify the level break associated with the trigger; and
cause the text to be read aloud from the level break associated with the trigger.

2. The apparatus of claim 1, wherein the trigger includes an identification of text within a specific paragraph and wherein the level break is a beginning of a sequential paragraph associated with the specific paragraph.

3. The apparatus of claim 1, wherein the trigger includes an identification of text within a specific paragraph and wherein the level break is at least one of the following: a beginning of the specific paragraph, a beginning of a specific sentence, a beginning of a specific column, a beginning of a specific page, an end of the specific paragraph, an end of the specific sentence, an end of the specific column, and an end of the specific page.

4. The apparatus of claim 1, wherein the trigger includes an identification of at least two intermediate portions of the text each a distance from a different level break in the text, and wherein the at least one processor device is further configured to select a level break associated with the trigger and cause the text to be read aloud from the selected level break.

5. The apparatus of claim 4, wherein the at least one processor device is further configured to select a level break based on context information.

6. The apparatus of claim 1, wherein the at least one processor device is further configured to perform an optical character recognition (OCR) only on a subset of the image data associated with the trigger prior to causing the text to be read aloud.

7. The apparatus of claim 6, wherein the at least one processor device is further configured to anticipate a subsequent paragraph to be read aloud and to perform an OCR of the subsequent paragraph in advance.

8. The apparatus of claim 6, wherein the at least one processor device is further configured to begin reading aloud the text prior to completion of a full OCR of the text, and to continue performance of the OCR while reading aloud is occurring.

9. The apparatus of claim 8, wherein the at least one processor device is further configured to begin reading aloud within less than 4 seconds of initiation of the OCR.

10. The apparatus of claim 8, wherein the at least one processor device is further configured to begin reading aloud within less than 3 seconds of initiation of the OCR.

11. The apparatus of claim 8, wherein the at least one processor device is further configured to begin reading aloud within less than 1 second of initiation of the OCR.

12. The apparatus of claim 1, wherein the image sensor is further configured to capture the image data in various resolutions.

13. The apparatus of claim 12, wherein the at least one processor device is further configured to operate in a low power consumption mode by performing the layout analysis on the image data taken at a resolution lower than a resolution of the image data used for processing the text.

14. An apparatus for performing at least one action on text retrieved from a captured image, the apparatus comprising:
an image sensor configured to be worn by a user and to capture image data from an environment of the user;
at least one processor device configured to:
determine an existence of a pointing trigger in the image data, wherein the pointing trigger identifies an intermediate portion of the text proximate to a level break in the text;
perform a layout analysis on the text to identify a level break associated with the pointing trigger; and
perform the at least one action on a portion of the text associated with the identified level break.

15. The apparatus of claim 14, wherein the pointing trigger includes an image of an elongated object chosen from a group consisting of a portion of a hand, a finger, a writing implement, a stylus, and a cane.

16. The apparatus of claim 14, wherein the at least one action includes at least one of: reading text aloud, performing an optical character recognition (OCR), summarizing text, processing text, translating text, and storing text.

17. The apparatus of claim 14, wherein the at least one processor device is further configured to automatically suspend performing the at least one action when a second trigger associated with a different intermediate portion of the text is determined, and to begin performing the at least one action from a level break associated with the different intermediate portion of the text in response to determination of the second trigger.

18. The apparatus of claim 14, wherein the at least one processor device is further configured to automatically stop performing the at least one action when the user looks away from the text.

19. The apparatus of claim 18, wherein the at least one processor device is further configured to automatically resume performing the at least one action when the user looks back at the text.

20. The apparatus of claim 18, wherein the at least one processor device is further configured to resume performing the at least one action from a previous stopping point when the user looks back at the text.

21. The apparatus of claim 14, wherein the at least one processor device is further configured to continue performing the at least one action on the portion of the text if the portion of the text is outside the image sensor's field of view, but was previously in the field of view.

22. The apparatus of claim 14, wherein the at least one processor device is further configured to use information retrieved from performing optical character recognition on the portion of the text associated with the identified level break to select at least one action to be performed on additional portions of the text.

23. The apparatus of claim 14, wherein the at least one processor device is further configured to use information retrieved from performing optical character recognition on the portion of the text associated with the identified level break to determine a next portion of the text upon which to perform the at least one action.

24. A method for audibly reading text retrieved from a captured image, the method comprising:
capturing real time image data from an environment of a user;
determining an existence of a trigger in the image data, the trigger being associated with a desire of the user to hear text read aloud, and wherein the trigger identifies an intermediate portion of the text a distance from a level break in the text;
performing a layout analysis on the text to identify the level break associated with the trigger; and
reading aloud text beginning from the level break associated with the trigger.

25. A software product stored on a non-transitory computer readable medium and comprising data and computer implementable instructions for carrying out the method of claim 24.
